(19) United States
(12) Patent Application Publication
(10) Pub. No.: US 2020/0058420 A1
(43) Pub. Date: Feb. 20, 2020

(54) METHOD AND AN APPARATUS FOR IMPROVING MAGNETIC PROPERTIES OF A FINISHED ND-FE-B MAGNET

(71) Applicant: Yantai Shougang Magnetic Materials, Inc., Yantai (CN)

(72) Inventors: XIULEI CHEN, Yantai (CN); Zhongjie Peng, Yantai (CN); GUANGYANG LIU, Yantai (CN); XIAONAN ZHU, Yantai (CN)

(21) Appl. No.: 16/543,265

(22) Filed: Aug. 16, 2019

(30) Foreign Application Priority Data
Aug. 16, 2018 (CN) 201810932329.X

(51) Int. Cl. H01F 1/057; H01F 1/055; H01F 41/02

(52) U.S. Cl. CPC H01F 1/057; H01F 41/0266; H01F 1/0557; H01F 1/0556

(57) ABSTRACT

A method of making a finished Nd—Fe—B magnet includes a first step of providing a rare earth magnet powder. Then, a green compact is formed using the rare earth magnet powder. The green compact includes at least one orientation surface, at least one non-orientation surface, and at least one pressing surface. Next, the green compact is cut using a cutting apparatus along the at least one orientation surface, the at least one non-orientation surface, or the at least one pressing surface, under an inert atmosphere to produce a plurality of sliced compacts. Then, the sliced compacts are sintered to produce sintered compacts. The sintered compacts are annealed to produce annealed compacts. The annealed compacts are then machined to obtain finished Nd—Fe—B magnets. The step of cutting is performed before the steps of sintering, annealing, and machining. A cutting apparatus for cutting the green compact is also disclosed herein.

### CROSS REFERENCE TO RELATED APPLICATION

This application claims priority to Chinese Application Serial Number CN201810932329.X filed on Aug. 16, 2018, the entire disclosure of which is incorporated herein by reference in its entirety.

### BACKGROUND OF THE INVENTION

### 1. Field of the Invention

The present invention generally relates to a method and an apparatus for making a finished Nd—Fe—B magnet.

### 2. Description of the Prior Art

For large Nd—Fe—B magnets, component segregation easily occurs during sintering and annealing processes. This phenomenon is caused by rare earth volatilization and capillary tension during liquid phase sintering process. This also results in a different elemental distribution at different locations of the compact, especially with rare earth elements. Accordingly, the different elemental distribution results in a difference in magnetic properties at different locations of the same compact. This situation will become more serious if the size of the compact is larger or the crystal grain size is smaller. In addition, the traditional Nd—Fe—B products are generally processed into finished products by mechanical processing, i.e. cutting, grinding, drilling, chamfering, etc., after sintering and annealing. The technology associated with the mechanical processing is relatively mature and easy to operate. It also has high machining efficiency and precision. However, during mechanical processing of the annealed compact, surface stress is generated on the product thereby causing damage to the surface crystal structure which results in attenuation of magnetic properties, which degrades the performance of the magnet from the blank. For products with large specific surface area and irregular shape, the magnetic attenuation caused by the mechanical processing is more serious. At the same time, a cutting fluid, e.g. a coolant, is used during the mechanical processing to providing cooling. Research shows that the cutting fluid can erode to a depth of several micrometers in the finished Nd—Fe—B magnet, which affect the magnetic properties and corrosion resistance of the finished Nd—Fe—B magnet.

Chinese patent CN105741994B provides a method of directly machining an Nd—Fe—B green compact into a finished product shape before sintering, thereby avoiding damage to the performance of the magnet during machining and maintaining the performance state of the magnet after heat treatment. However, there are some shortcomings in the method of completely machining the green compact into a finished product before sintering. Machining the green compact by using conventional equipment and methods has great problems in operability and precision, because the density of the green compact is too low compared with the sintered blank. Green compact is easy to be damaged while machining and the pass rate is reduced. To ensure that each machining step is carried out in an inert gas atmosphere or protective oil, the equipment requirements are stricter and the cost is increased. Moreover, it is difficult to process the green compact directly into finished products if the product size is too small which leads to poor the precision. And for some products with curved profile or irregular shape, the sintering shrinkage rate in different directions is difficult to calculate accurately, which may cause a large deviation from the target product size. In addition, machining the green compact directly into product size before sintering will increase the surface area, which will cause easier nitride and oxidize while sintering. Thereby reducing the magnetic performance of the magnet.

### SUMMARY OF THE INVENTION

The present invention overcomes the deficiencies mentioned above and provides a method of making a finished Nd—Fe—B magnet. The present invention also provides a finished Nd—Fe—B magnets having improved product uniformity and improved magnetic properties. In addition, the present invention provides a method that has an improved utilization rate of the rare earth magnet powders.

It is one aspect of the present invention to provide a method of making a finished Nd—Fe—B magnet. The method includes a first step of providing a rare earth magnet powder. The next step of the method includes forming a green compact using the rare earth magnet powder with the green compact including at least one orientation surface, at least one non-orientation surface, and at least one pressing surface. The method then proceeds with a step of cutting the green compact using a cutting apparatus along one of the at least one orientation surface, the at least one non-orientation surface, or the at least one pressing surface, under an inert atmosphere to produce a plurality of sliced compacts. Next, the sliced compacts are sintered to produce a plurality of sintered compacts. The, the sintered compacts are annealed to produce a plurality of annealed compacts. After annealing, the annealed compacts are machined to obtain a plurality of finished Nd—Fe—B magnets. The step of cutting is performed before the steps of sintering, annealing, and machining to effectively decrease amount of undesired material formation during the step of sintering thereby improving the magnetic properties of the finished Nd—Fe—B magnets. Preferably, only one or two surfaces selected from the at least one orientation surface, the at least one non-orientation surface, or the at least one pressing surface is processed during the cutting step. This is because processing all the surfaces will effectively increase the surface areas of the sliced compacts thereby allowing the sliced compacts to be more easily oxidized which negatively affect the magnetic properties of the finished Nd—Fe—B magnets.

It is another aspect of the present invention to provide cutting apparatus for cutting the green compact. The apparatus comprises a frame including a first portion and a second portion. A pair of support members extends between the first portion and the second portion connecting the first portion and the second portion. The first portion, the second portion, and the support members defines a chamber extending therebetween. A cutter, located in the chamber, connects to the first portion and is movable along the first portion in a parallel relationship with the first portion for cutting the green compact. A container, disposed in the chamber and located between the cutter and the second portion, defining a pocket for receiving the green compact, connects to the second portion and is movable between a first position and a second position. In the first position, the container is located adjacent to the cutter. In the second position, the container is located adjacent to the second portion. An actuator attaches to the first portion and coupled to the cutter for moving the cutter along the first portion. At least one drive unit attaches to the second portion and connected to the container for raising and lowering the container between the first position and the second position.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a cross-sectional side view of an apparatus for improving magnetic properties for a finished Nd—Fe—B magnet constructed according one embodiment of the present invention;

FIG. 2 is a perspective view of a container of the apparatus for receiving a green compact constructed according to one embodiment of the present invention; and

FIG. 3 is a perspective view of a cutting tool of the apparatus constructed according to one embodiment of the present invention.

### DESCRIPTION OF THE ENABLING EMBODIMENT

Referring to the Figures, wherein like numerals indicate corresponding parts throughout the several views, it is one aspect of the present invention to provide a method of making a finished Nd—Fe—B magnet.

The method includes a first step of providing a rare earth magnet powder. According one embodiment of the present invention the rare earth magnet powder has a particle size of 4.0 μm and a composition comprising: at least one light rare earth element including Pr and Nd being present at 31.10 wt. %; a heavy rare earth element of Dy being present at 1.50 wt. %; B being present at 0.95 wt. %; Co being present at 1.05 wt. %; Al being present at 0.51 wt. %; Cu being present at 0.15 wt. %; Ga being present at 0.12 wt. %; Ti being present at 0.11 wt. %; Fe being present as the balance; and inevitable impurities.

The method then proceeds with a step of forming a green compact using the rare earth magnet powder. The green compact includes at least one orientation surface, at least one non-orientation surface, and at least one pressing surface. The at least one orientation surface is parallel to an orientation magnetic field and not in contact with a press. The at least one pressing surface is in contact with the press. The at least one non-orientation surface is perpendicular to the at least one orientation surface and the at least pressing surface. The step of forming the green compact includes a step of pressing the magnetic powders, using the press, under a magnetic field to produce an initial compact. Next, the green compact is produced by isostatic pressing the initial compact under an isostatic pressure of between 150 MPa and 400 MPa. The green compact has a density of between 4.5-5.5 g/cm³.

Next, the method proceeds with a step of cutting the green compact using a cutting apparatus along one of the at least one orientation surface, the at least one non-orientation surface, or the at least one pressing surface, under an inert atmosphere to produce a plurality of sliced compacts. Preferably, the inert atmosphere contains a noble gas, e.g. Argon, or Nitrogen. The step of cutting is performed before sintering, annealing, and machining, to effectively decrease amount of undesired material formation during the step of sintering thereby improving the magnetic properties of the finished Nd—Fe—B magnets. Preferably, only one or two surfaces selected from the at least one orientation surface, the at least one non-orientation surface, or the at least one pressing surface is processed during the cutting step. This is because processing all the surfaces will effectively increase the surface areas of the sliced compacts thereby allowing the sliced compacts to be more easily oxidized which negatively affect the magnetic properties of the finished Nd—Fe—B magnets.

Then, the method proceeds with sintering the sliced compacts to produce a plurality of sintered compacts. The step of sintering is further defined as heating the sliced compacts in a vacuum furnace under a predetermined pressure of no more than 5×10⁻¹ Pa and at a sintering temperature of between 980° C. and 1040° C. After sintering, the sintered compacts are first cooled and then annealed, under the predetermined pressure, to produce a plurality of annealed compacts. The step of annealing is defined as heating the sintered compacts under a first annealing temperature of between 800° C. and 900° C. The step of annealing further includes a step of heating the sintered compacts under a second annealing temperature of between 480° C. and 600° C. to produce the annealed compacts. After annealing, the annealed compacts are machined to obtain a plurality of finished Nd—Fe—B magnets. The step of machining is further defined as machining the at least one orientation surface, the at least one non-orientation surface, or the at least one pressing surface that has not been processed during the step of cutting.

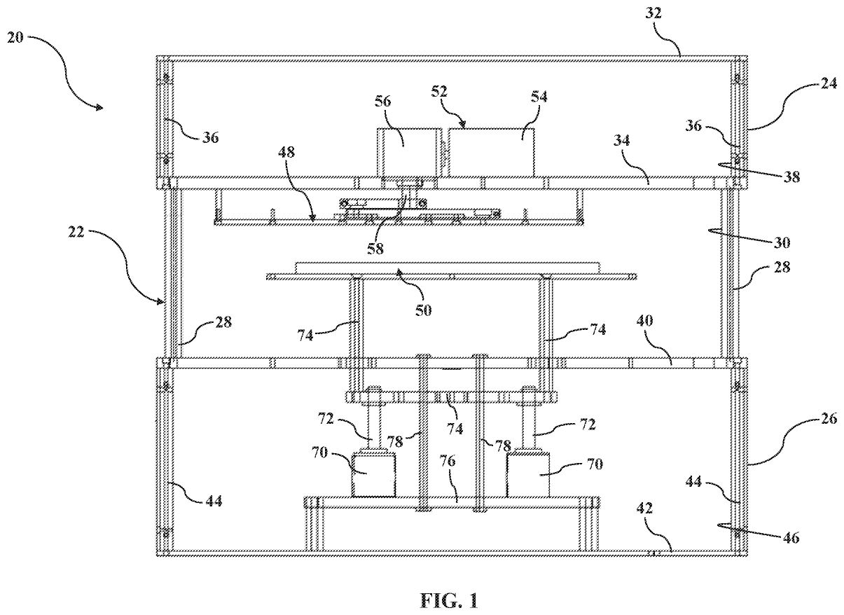

It is another aspect of the present invention to provide a cutting apparatus 20 for cutting a green compact. The cutting apparatus 20, constructed in accordance with one embodiment of the present invention, is generally shown in FIG. 1.

As best shown in FIG. 1, the cutting apparatus 20 includes a frame 22 having a first portion 24 and a second portion 26. The first portion 24 and the second portion 26, each having a rectangular shape, are spaced from one another. A pair of support members 28, spaced from one another, extends between the first portion 24 and the second portion 26 connecting the first portion 24 and the second portion 26 and defining a chamber 30 extending between the first portion 24 and the second portion 26. The first portion 24 includes a top 32 and a bottom 34 spaced from one another. A pair of vertical members 36, spaced from one another, extends between the vertical members 36, the top 32, and the bottom 34 connecting the top 32 to the bottom 34 and defines a compartment 38 extending between the vertical members 36, the top 32, and the bottom 34. The second portion 26 includes an upper part 40 and a lower part 42 spaced one another. A pair of intermediate members 44, spaced from one another, extends between the upper part 40 and the lower part 42 connecting the upper part 40 and the lower part 42 and defines a spacing 46 extending between the intermediate members 44, the upper part 40, and the lower part 42.

A cutter 48 is disposed in the chamber 30 and connected to the first portion 24, spaced from the bottom 34 of the first portion 24, and movable along the first portion 24 in a parallel relationship with the first portion 24. A container 50 is disposed in the chamber 30, located between the cutter 48 and the upper part 40 of the second portion 26, and connects to the second portion 26. The container 50 is movable between a first position and a second position. In the first position, the container 50 is located adjacent to the cutter 48. In the second position, the container is located adjacent to the second portion 26.

An actuator 52, located in the compartment 38, attaches to the bottom 34 of the first portion 24 and couples to the cutter 48 for moving the cutter 48 along the first portion 24. The actuator 52 includes a motor 54 and a reducer 56. The motor 54, located in the compartment 38, attaches to the bottom 34 for providing a rotational movement. The reducer 56 is disposed adjacent to the motor 54 and coupled to the motor 54 for reducing the rotational speed of the rotor 54. A linking member 58 couples to the reducer 56 and the cutter 48 for translating a rotational movement of the reducer 56 into a linear movement thereby allowing the cutter 48 to move along the first portion 24.

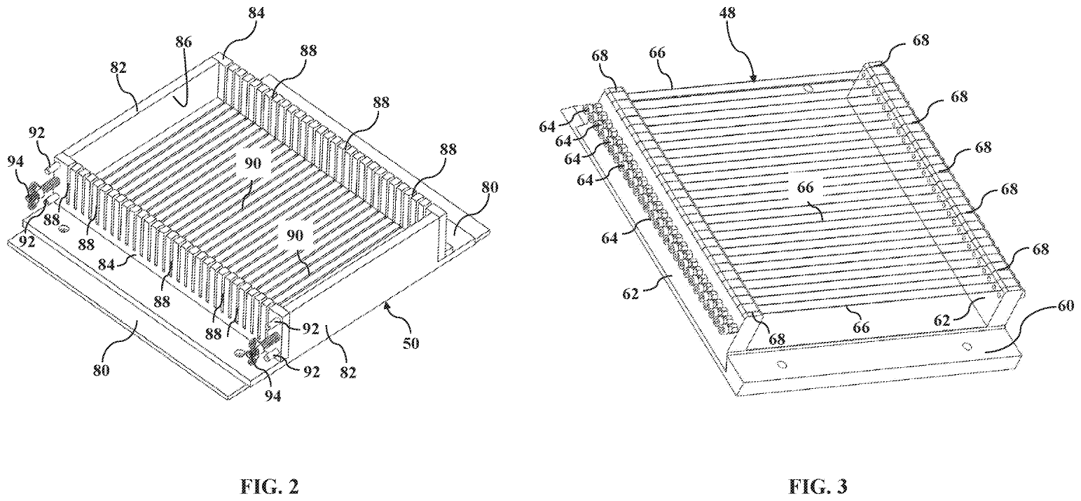

As best shown in FIG. 3, the cutter 48 includes a fixing plate 60, having a generally rectangular shape, movably attached to the linking member 58 adjacent to the first portion 24. A pair of side portions 62, opposite and spaced from one another, extends outwardly from the fixing plate 60. A plurality of fasteners 64 is mounted on each of the side portions 62 and disposed in a linear arrangement along the side portions 62. A plurality of wires 66 extends between the side portions 62 and attaches to the fasteners 64 whereby rotating the fasteners 64 can adjust the tension of the wires 66. Each of the side portions 62 defines a plurality of slots 68, located adjacent to the fasteners 64, for receiving the wires 66.

Referring back to FIG. 1, the cutting apparatus 20 includes at least one drive unit 70, located in the spacing 46, attached to the lower part 42 of the second portion 26 and connected to the container 50 for raising and lowering the container 50 between the first position and the second position. According to one embodiment of the present invention, the at least one drive unit 70 includes a pair of drive units 70 spaced from one another. Each of the drive units 70 includes shaft 72 attached to the container 50 via a bracket 74 for moving the container 50 between the first position and the second position. A platform 76 is disposed in the spacing 46, between the drive units 70 and the lower part 42 of the second portion 26 to provide support to the drive unit 70. A pair of mounting members 78, disposed in the spacing 46 and spaced from one another, extends between the platform 76 and the upper part 40 of the second portion 26 attaching the platform 76 to the upper part 40 to provide support to the platform 76.

As best shown in FIG. 2, the container 50 includes a base 80, having a generally rectangular shape, attaching to the shaft 72 of the drive units 70 for movement with the drive units 70. A pair of guide plates 82, opposite and spaced from one another, extends outwardly from the base 80. A pair of trunk plates 84, opposite and spaced from one another, is disposed adjacent to the guide plates 82 and perpendicular to the guide plates 82 defining a pocket 86 extending between the trunk plates 84 and said guide plates 82 for receiving a green compact. Each of the trunk plates 84 includes a plurality of openings 88, spaced from one another, extending along the trunk plates 84. The base 80 includes a plurality of grooves 90 extending across the base 80, in alignment and communication with the openings 88 for receiving the wires 66 to allow the cutter 48 to cut the green compact disposed in the pocket 86. Each of the guide plates 82 includes a pair of guiding pins 92, spaced from one another, extending through at least one of the trunk plates 84 to ensure proper alignment of the trunk plates 84 relative to the guide plates 82. Each of the guide plates 82 includes an adjustment bolt 94, located between the guiding pins 92, extending through at least one of the trunk plates 84 to allow for adjustments based on different sizes of the green compact. It should be appreciated that the grooves 90 and the openings 88 can vary in size to allow for larger or smaller cuts to the green compact.

In operation, the green compact is first disposed in the pocket 86 of the container 50. The trunk plates 84 are then secured to the guide plates 82 to retain the green compact in the pocket 86. It should be appreciated that the trunk plates 84 can be adjusted based on the size of the green compact to properly accommodate the green compact allowing the green compact to properly fit inside the pocket 86. To cut the green compact, the motor 54 first provides a rotational movement to the reducer 56. In response to the rotational movement, the reducer 56, i.e. a gear box, first reduces rotational movement of the motor 54 and outputs a slower and a smoother rotational movement. The linking member 58 translates the rotational movement of the reducer 56 into a linear movement thereby allowing the cutter 48 to move horizontally along the first portion 24. The drive units 70 moves the container vertically toward the cutter 48. Based on the horizontal movement of the cutter 48, the wires 66 slice through the green compact to produce the plurality of sliced compacts. During the cutting of the green compact, as the wires 66 slice through the green compact, rare earth magnet powders are generated during the cutting process. The rare earth magnet powders can be recycled into a second mold to form another green compact thereby improving the utilization rate of the rare earth magnet powders.

The examples below provide a better illustration of the present invention. The examples are used for illustrative purposes only and do not limit the scope of the present invention.

### IMPLEMENTING EXAMPLE 1

For Implementing Example 1, a finished Nd—Fe—B magnet having a dimension of 10.0 mm (along a non-orientation surface)×6.5 mm (along an orientation surface)×8.0 mm (along a pressing surface) is produced. For Implementing Example 1, the non-orientation surface of a green compact is processed using the cutting apparatus. The orientation surface and pressing surface are machined after annealing.

To manufacture the finished Nd—Fe—B magnet of Implementing Example 1, a rare earth magnet powder is first provided. The rare earth magnet powder has an average particle size (X₅₀) of 4.0 μm. The rare earth magnet powder also has a composition including: Pr+Nd being present at 31.10 wt. %; Dy being present at 1.50 wt. %; B being present at 0.95 wt. %; Co being present at 1.05 wt. %; Al being present at 0.51 wt. %; Cu being present at 0.15 wt. %; Ga being present at 0.12 wt. %; Ti being present at 0.11 wt. %; and the balance being Fe and inevitable impurity elements.

Next, the rare earth magnet powder is formed into a green compact by pressing the rare earth magnet powder under a magnetic field of 2.0 T to produce an initial compact. Then, the initial compact is subjected to an isostatic pressing under an isostatic pressure of 150 MPa to produce the green compact. The green compact has a weight of 610.7 g, a density of 4.5 g/cm³, and a dimension of 79.3 mm (along a non-orientation surface)×38.2 mm (along an orientation surface)×44.8 mm (along a pressing surface). The at least one orientation surface is parallel to an orientation magnetic field and not in contact with a press. The at least one pressing surface is in contact with the press. The at least one non-orientation surface is perpendicular to the at least one orientation surface and the at least pressing surface.

Then, the green compact is placed in the pocket of the container. The trunk plates are secured to the guide plates, via bolt or fasteners, thereby securing the green compact in the pocket. The opening of the trunk plates is 11.3 mm. The grooves of the base of the container is 11.3 mm. The wires of the cutter has a diameter of 0.3 mm. The green compact is then cut, along the non-orientation surface and under the inert atmosphere containing Nitrogen, into a plurality of seven sliced compacts using the cutter. Each of the sliced compacts has a dimension of 11.0 mm (along the non-orientation surface)×38.2 mm (along the orientation surface)×44.8 mm (along the pressing surface). The excess rare earth powder produced during the cutting process are collected using a second molding and can be recycled into manufacturing another green compact.

The sliced compacts are sintered, under a sintering temperature of 980° C. and a predetermined pressure of no more than 5×10⁻¹ Pa for a sintering duration of 10 hours, to produce a plurality of sintered compacts. After sintering, the sintered compacts are first cooled and then annealed, under the predetermined pressure of no more than 5×10⁻¹ Pa, to produce a plurality of annealed compacts. During the step of annealing, the sintered compacts are heated under a first annealing temperature of between 800° C. for a first annealing duration of 3 hours. Then, the sintered compacts are heated again under a second annealing temperature of 480° C. for a second annealing duration of 3 hours. After annealing, the annealed compacts are machined to obtain a plurality of finished Nd—Fe—B magnets. The orientation surface and the pressing surface of the annealed compacts are first subjected to a wire cutting process and are polished after the wire cutting process wherein the non-orientation surface only needs to be polished. After machining, a plurality of 140 finished Nd—Fe—B magnets are obtained with each of the finished Nd—Fe—B magnets has a size of 10. mm×6.5 mm×8.0 mm. During the cutting process, each of the sliced compact produces 13.8 g of rare earth magnet powder, which can be recycled into manufacturing another green compact. During the sintering, annealing, and machining steps, 50.5 g of waste rare earth powder is generated. According the total weight of the finished Nd—Fe—B magnet is 546.0 g and the comprehensive utilization rate of the rare earth powder is 91.7%. Twenty pieces of the finished Nd—Fe—B magnets are selected for analysis. The total rare earth element (TRE) content and the magnetic properties are listed below in Table 1.

TABLE 1
TRE and Magnetic Properties of the Finished Nd—Fe—B
Magnets of Implementing Example 1

| | TRE | | | | O | N |
|---|---|---|---|---|---|---|
| Sample | (wt. %) | Br(kGs) | Hcj(kOe) | Hk/Hcj | (ppm) | (ppm) |
| 1 | 30.97 | 13.23 | 22.2 | 0.97 | 692 | 384 |
| 2 | 31.20 | 13.16 | 22.5 | 0.98 | 686 | 365 |
| 3 | 30.98 | 13.22 | 22.2 | 0.98 | 688 | 364 |
| 4 | 31.02 | 13.20 | 22.4 | 0.98 | 677 | 365 |
| 5 | 31.03 | 13.21 | 22.3 | 0.99 | 705 | 354 |
| 6 | 31.20 | 13.16 | 22.4 | 0.98 | 685 | 397 |
| 7 | 31.18 | 13.17 | 22.4 | 0.97 | 654 | 368 |
| 8 | 31.20 | 13.18 | 22.5 | 0.96 | 687 | 384 |
| 9 | 31.15 | 13.20 | 22.3 | 0.95 | 692 | 389 |
| 10 | 31.16 | 13.21 | 22.3 | 0.98 | 657 | 401 |
| 11 | 31.16 | 13.20 | 22.3 | 0.97 | 659 | 412 |
| 12 | 30.98 | 13.21 | 22.2 | 0.96 | 687 | 378 |
| 13 | 30.97 | 13.23 | 22.2 | 0.97 | 668 | 365 |
| 14 | 31.00 | 13.20 | 22.2 | 0.98 | 649 | 396 |
| 15 | 31.02 | 13.21 | 22.3 | 0.99 | 696 | 396 |
| 16 | 31.08 | 13.19 | 22.3 | 0.97 | 703 | 411 |
| 17 | 31.18 | 13.16 | 22.4 | 0.98 | 696 | 374 |
| 18 | 31.18 | 13.16 | 22.5 | 0.98 | 655 | 396 |
| 19 | 31.16 | 13.17 | 22.3 | 0.98 | 694 | 387 |
| 20 | 31.10 | 13.21 | 22.3 | 0.98 | 668 | 366 |
| max | 31.20 | 13.23 | 22.5 | 0.99 | 705 | 412 |
| min | 30.97 | 13.16 | 22.2 | 0.95 | 649 | 354 |
| max − min | 0.23 | 0.07 | 0.3 | 0.04 | 56 | 58 |
| ave | 31.10 | 13.19 | 22.3 | 0.97 | 680 | 383 |
| δ | 0.09 | 0.02 | 0.10 | 0.01 | | |

As illustrated in Table 1 above, the maximum value of the total rare earth element content (TRE) is 31.2 wt. %, the minimum value of the TRE is 30.97 wt. %, the maximum deviation is 0.23 wt. %, the standard deviation is 0.09. The maximum value of Br is 13.23 kGs, the minimum value is 13.16 kGs, the maximum deviation of Br is 0.07 kGs, the standard deviation is 0.02. The maximum value of Hcj is 22.5 kOe, the minimum is 22.2 kOe, the average value is 22.3 kOe, the maximum deviation is 0.3 kOe, the standard deviation is 0.10. The average squareness (Hk/Hcj) value is 0.97. The average value of O element content is 680 ppm, and the average value of N element content is 383 ppm.

### IMPLEMENTING EXAMPLE 2

For Implementing Example 2, a finished Nd—Fe—B magnet having a dimension of 10.0 mm (along a non-orientation surface)×6.5 mm (along an orientation surface)×8.0 mm (along a pressing surface) is produced. For Implementing Example 2, the non-orientation and the orientation surfaces of a green compact is processed using the cutting apparatus.

To manufacture the finished Nd—Fe—B magnet of Implementing Example 2, a rare earth magnet powder is first provided. The rare earth magnet powder has an average particle size (X₅₀) of 4.0 μm. The rare earth magnet powder also has a composition including: Pr+Nd being present at 31.10 wt. %; Dy being present at 1.50 wt. %; B being present at 0.95 wt. %; Co being present at 1.05 wt. %; Al being present at 0.51 wt. %; Cu being present at 0.15 wt. %; Ga being present at 0.12 wt. %; Ti being present at 0.11 wt. %; and the balance being Fe and inevitable impurity elements.

Next, the rare earth magnet powder is formed into a green compact by pressing the rare earth magnet powder under a magnetic field of 2.0 T to produce an initial compact. Then, the initial compact is subjected to an isostatic pressing under an isostatic pressure of 400 MPa to produce the green compact. The green compact has a weight of 609.7 g, a density of 5.5 g/cm³, and a dimension of 75.7 mm (along a non-orientation surface)×33.9 mm (along an orientation surface)×43.2 mm (along a pressing surface). The at least one orientation surface is parallel to an orientation magnetic field and not in contact with a press. The at least one pressing surface is in contact with the press. The at least one non-orientation surface is perpendicular to the at least one orientation surface and the at least pressing surface.

Then, the green compact is placed in the pocket of the container. The trunk plates are secured to the guide plates, via bolt or fasteners, thereby securing the green compact in the pocket. The opening of the trunk plates is 10.8 mm. The grooves of the base of the container is 10.8 mm. The wires of the cutter has a diameter of 0.3 mm. The green compact is then cut, along the non-orientation surface and under the inert atmosphere containing Argon, into a plurality of seven sliced compacts using the cutter. Each of the sliced compacts has a dimension of 10.5 mm (along the non-orientation surface)×33.9 mm (along the orientation surface)×43.2 mm (along the pressing surface). Then, the trunk plates are replaced with a second pair of trunk plates wherein the opening of the second pair of trunk plates is 8.4 mm. In addition, the base is replaced with a second base wherein the grooves of the second base is 8.4 mm. The sliced compacts are the further cut, along the orientation surface, using the cutter to produce a plurality of 28 sliced compacts. Each of the sliced compacts has a dimension of 10.5 mm (along the non-orientation surface)×8.1 mm (along the orientation surface)×43.2 mm (along the pressing surface). The excess rare earth powder produced during the cutting process are collected using a second molding and can be recycled into manufacturing another green compact.

The sliced compacts are sintered, under a sintering temperature of 1040° C. and a predetermined pressure of no more than 5×10⁻¹ Pa for a sintering duration of 7 hours, to produce a plurality of sintered compacts. After sintering, the sintered compacts are first cooled and then annealed, under the predetermined pressure of no more than 5×10⁻¹ Pa, to produce a plurality of annealed compacts. During the step of annealing, the sintered compacts are heated under a first annealing temperature of between 900° C. for a first annealing duration of 3 hours. Then, the sintered compacts are heated again under a second annealing temperature of 600° C. for a second annealing duration of 3 hours. After annealing, the annealed compacts are machined to obtain a plurality of finished Nd—Fe—B magnets. The pressing surface of the annealed compacts are first subjected to a wire cutting process and are polished after the wire cutting process wherein annealed compacts are polished. After machining, a plurality of 140 finished Nd—Fe—B magnets are obtained with each of the finished Nd—Fe—B magnets has a size of 10. mm×6.5 mm×.8.0 mm. During the cutting process, each of the sliced compact produces 36.2 g of rare earth magnet powder, which can be recycled into manufacturing another green compact. During the sintering, annealing, and machining steps, 25.8 g of waste rare earth powder is generated. According the total weight of the finished Nd—Fe—B magnet is 546.0 g and the comprehensive utilization rate of the rare earth powder is 95.3%. Twenty pieces of the finished Nd—Fe—B magnets are selected for analysis. The total rare earth element (TRE) content and the magnetic properties are listed below in Table 2.

TABLE 2
TRE and Magnetic Properties of the Finished Nd—Fe—B Magnets
of Implementing Example 2

| | TRE | Br | Hcj | | O | N |
|---|---|---|---|---|---|---|
| Sample | (wt. %) | (kGs) | (kOe) | Hk/Hcj | (ppm) | (ppm) |
| 1 | 31.03 | 13.22 | 22.3 | 0.97 | 691 | 394 |
| 2 | 31.07 | 13.21 | 22.4 | 0.98 | 694 | 375 |
| 3 | 31.17 | 13.18 | 22.4 | 0.98 | 686 | 369 |
| 4 | 31.12 | 13.20 | 22.4 | 0.98 | 687 | 375 |
| 5 | 31.09 | 13.19 | 22.3 | 0.99 | 722 | 374 |
| 6 | 31.10 | 13.19 | 22.4 | 0.98 | 657 | 401 |
| 7 | 31.10 | 13.19 | 22.4 | 0.97 | 705 | 415 |
| 8 | 31.04 | 13.21 | 22.3 | 0.96 | 687 | 394 |
| 9 | 31.04 | 13.21 | 22.4 | 0.95 | 725 | 388 |
| 10 | 31.05 | 13.21 | 22.3 | 0.98 | 697 | 407 |
| 11 | 31.16 | 13.18 | 22.5 | 0.97 | 675 | 420 |
| 12 | 31.07 | 13.21 | 22.4 | 0.96 | 701 | 401 |
| 13 | 31.09 | 13.20 | 22.4 | 0.97 | 696 | 374 |
| 14 | 31.09 | 13.20 | 22.4 | 0.98 | 667 | 423 |
| 15 | 31.08 | 13.19 | 22.4 | 0.99 | 702 | 396 |
| 16 | 31.09 | 13.19 | 22.3 | 0.97 | 696 | 411 |
| 17 | 31.16 | 13.18 | 22.5 | 0.98 | 678 | 387 |
| 18 | 31.05 | 13.20 | 22.4 | 0.98 | 685 | 395 |
| 19 | 31.16 | 13.18 | 22.5 | 0.98 | 701 | 397 |
| 20 | 31.10 | 13.20 | 22.3 | 0.98 | 679 | 401 |
| max | 31.17 | 13.22 | 22.5 | 0.99 | 725 | 423 |
| min | 31.03 | 13.18 | 22.3 | 0.95 | 657 | 369 |
| max − min | 0.14 | 0.04 | 0.2 | 0.04 | 68 | 54 |
| ave | 31.09 | 13.20 | 22.4 | 0.97 | 692 | 395 |
| δ | 0.04 | 0.01 | 0.07 | 0.01 | | |

As illustrated in Table 2 above, the maximum total rare earth element content (TRE) is 31.17 wt. %, the minimum value is 31.03 wt. %, the maximum deviation is 0.14 wt. %, the standard deviation is 0.04. The maximum value of Br is 13.22 kGs, the minimum value is 13.18 kGs, the maximum deviation of Br is 0.04 kGs, the standard deviation is 0.01. The maximum value of Hcj is 22.5 kOe, the minimum is 22.3 kOe, the average value is 22.4 kOe, the maximum deviation is 0.2 kOe, the standard deviation is 0.07. The average squareness (Hk/Hcj) value is 0.97. The average value of O element content is 692 ppm, and the average value of N element content is 395 ppm.

### COMPARATIVE EXAMPLE 1

For Comparative Example 1, a finished Nd—Fe—B magnet having a dimension of 10.0 mm (along a non-orientation surface)×6.5 mm (along an orientation surface)×8.0 mm (along a pressing surface) is produced. For Comparative Example 1, no machining process is carried out for the green compact. The finished Nd—Fe—B magnets are obtained by machining after the step of annealing.

To manufacture the finished Nd—Fe—B magnet of Comparative Example 1, a rare earth magnet powder is first provided. The rare earth magnet powder has an average particle size (X₅₀) of 4.0 μm. The rare earth magnet powder also has a composition including: Pr+Nd being present at 31.10 wt. %; Dy being present at 1.50 wt. %; B being present at 0.95 wt. %; Co being present at 1.05 wt. %; Al being present at 0.51 wt. %; Cu being present at 0.15 wt. %; Ga being present at 0.12 wt. %; Ti being present at 0.11 wt. %; and the balance being Fe and inevitable impurity elements.

Next, the rare earth magnet powder is formed into a green compact by pressing the rare earth magnet powder under a magnetic field of 2.0 T to produce an initial compact. Then, the initial compact is subjected to an isostatic pressing under an isostatic pressure of 400 MPa to produce the green compact. The green compact has a weight of 609.7 g, a density of 5.5 g/cm³, and a dimension of 75.7 mm (along a non-orientation surface)×33.9 mm (along an orientation surface)×43.2 mm (along a pressing surface). The at least one orientation surface is parallel to an orientation magnetic field and not in contact with a press. The at least one pressing surface is in contact with the press. The at least one non-orientation surface is perpendicular to the at least one orientation surface and the at least pressing surface.

Then, the green compact is sintered, under a sintering temperature of 1040° C. and a predetermined pressure of no more than 5×10⁻¹ Pa for a sintering duration of 7 hours, to produce a sintered compact. After sintering, the sintered compact is first cooled and then annealed, under the predetermined pressure of no more than 5×10⁻¹ Pa, to produce an annealed compact. During the step of annealing, the sintered compact is heated under a first annealing temperature of 900° C. for a first annealing duration of 3 hours. Then, the sintered compact is heated again under a second annealing temperature of 600° C. for a second annealing duration of 3 hours. After annealing, the annealed compacts are machined to obtain a plurality of 140 finished Nd—Fe—B magnets. Each of the finished Nd—Fe—B magnets has a size of 10. mm×6.5 mm×.8.0 mm. During the sintering, annealing, and machining steps, 64.4 g of waste rare earth powder is generated. According the total weight of the finished Nd—Fe—B magnet is 546.0 g and the comprehensive utilization rate of the rare earth powder is 89.6%. Twenty pieces of the finished Nd—Fe—B magnets are selected for analysis. The total rare earth element (TRE) content and the magnetic properties are listed below in Table 3.

TABLE 3
TRE and Magnetic Properties of the Finished Nd—Fe—B Magnets
of Comparative Example 1

| | TRE | Br | Hcj | | O | N |
|---|---|---|---|---|---|---|
| Sample | (wt. %) | (kGs) | (kOe) | Hk/Hcj | (ppm) | (ppm) |
| 1 | 31.35 | 13.14 | 22.30 | 0.95 | 672 | 353 |
| 2 | 31.24 | 13.16 | 22.20 | 0.96 | 675 | 346 |
| 3 | 31.15 | 13.18 | 21.90 | 0.96 | 664 | 348 |
| 4 | 31.02 | 13.23 | 21.80 | 0.96 | 684 | 389 |
| 5 | 31.03 | 13.21 | 21.90 | 0.97 | 695 | 355 |
| 6 | 31.24 | 13.16 | 22.20 | 0.96 | 678 | 396 |
| 7 | 30.76 | 13.26 | 21.70 | 0.95 | 632 | 347 |
| 8 | 30.88 | 13.24 | 21.80 | 0.94 | 667 | 384 |
| 9 | 30.91 | 13.23 | 21.80 | 0.95 | 668 | 386 |
| 10 | 31.39 | 13.11 | 22.30 | 0.96 | 634 | 359 |
| 11 | 30.92 | 13.24 | 21.70 | 0.95 | 647 | 334 |
| 12 | 30.85 | 13.25 | 21.80 | 0.94 | 678 | 364 |
| 13 | 31.01 | 13.23 | 21.90 | 0.95 | 632 | 361 |
| 14 | 31.12 | 13.19 | 22.00 | 0.96 | 657 | 375 |
| 15 | 31.05 | 13.22 | 21.90 | 0.97 | 679 | 376 |
| 16 | 30.88 | 13.25 | 21.80 | 0.95 | 643 | 347 |
| 17 | 30.82 | 13.25 | 21.80 | 0.96 | 656 | 356 |
| 18 | 31.26 | 13.18 | 22.10 | 0.96 | 634 | 401 |
| 19 | 31.35 | 13.13 | 22.30 | 0.96 | 674 | 374 |
| 20 | 31.42 | 13.10 | 22.40 | 0.96 | 687 | 368 |
| max | 31.42 | 13.26 | 22.40 | 0.97 | 695 | 401 |
| min | 30.76 | 13.10 | 21.70 | 0.94 | 632 | 334 |
| max − min | 0.66 | 0.16 | 0.70 | 0.03 | 63 | 67 |
| ave | 31.08 | 13.20 | 21.9 | 0.96 | 663 | 366 |
| δ | 0.21 | 0.05 | 0.23 | 0.01 | | |

As illustrated in Table 3 above, the maximum total rare earth element content (TRE) is 31.42 wt. %, the minimum value is 30.76 wt. %, the maximum deviation is 0.66 wt. %, the standard deviation is 0.21. The maximum value of Br is 13.26 kGs, the minimum value is 13.10 kGs, the maximum deviation of Br is 0.16 kGs, the standard deviation is 0.05. The maximum value of Hcj is 22.4 kOe, the minimum is 21.7 kOe, the average value is 21.9 kOe, the maximum deviation is 0.7 kOe, the standard deviation is 0.23. The average squareness (Hk/Hcj) value is 0.96. The average value of O element content is 663 ppm, and the average value of N element content is 366 ppm.

### COMPARATIVE EXAMPLE 2

For Comparative Example 2, a finished Nd—Fe—B magnet having a dimension of 10.0 mm (along a non-orientation surface)×6.5 mm (along an orientation surface)×8.0 mm (along a pressing surface) is produced. For Comparative Example 2, the non-orientation, the orientation, and the pressing surfaces of a green compact are processed using the cutting apparatus.

To manufacture the finished Nd—Fe—B magnet of Comparative Example 2, a rare earth magnet powder is first provided. The rare earth magnet powder has an average particle size (X₅₀) of 4.0 μm. The rare earth magnet powder also has a composition including: Pr+Nd being present at 31.10 wt. %; Dy being present at 1.50 wt. %; B being present at 0.95 wt. %; Co being present at 1.05 wt. %; Al being present at 0.51 wt. %; Cu being present at 0.15 wt. %; Ga being present at 0.12 wt. %; Ti being present at 0.11 wt. %; and the balance being Fe and inevitable impurity elements.

Next, the rare earth magnet powder is formed into a green compact by pressing the rare earth magnet powder under a magnetic field of 2.0 T to produce an initial compact. Then, the initial compact is subjected to an isostatic pressing under an isostatic pressure of 400 MPa to produce the green compact. The green compact has a weight of 609.7 g, a density of 5.5 g/cm³, and a dimension of 75.7 mm (along a non-orientation surface)×33.9 mm (along an orientation surface)×43.2 mm (along a pressing surface). The at least one orientation surface is parallel to an orientation magnetic field and not in contact with a press. The at least one pressing surface is in contact with the press. The at least one non-orientation surface is perpendicular to the at least one orientation surface and the at least pressing surface.

Then, the green compact is placed in the pocket of the container. The trunk plates are secured to the guide plates, via bolt or fasteners, thereby securing the green compact in the pocket. The opening of the trunk plates is 10.8 mm. The grooves of the base of the container is 10.8 mm. The wires of the cutter has a diameter of 0.3 mm. The green compact is then cut, along the non-orientation surface and under the inert atmosphere containing Argon, into a plurality of seven sliced compacts using the cutter. Each of the sliced compacts has a dimension of 10.5 mm (along the non-orientation surface)×33.9 mm (along the orientation surface)×43.2 mm (along the pressing surface). Then, the trunk plates are replaced with a second pair of trunk plates wherein the opening of the second pair of trunk plates is 8.4 mm. In addition, the base is replaced with a second base wherein the grooves of the second base is 8.4 mm. The sliced compacts are then further cut, along the orientation surface under the inert atmosphere containing Argon, using the cutter to produce a plurality of 28 sliced compacts. Each of the sliced compacts has a dimension of 10.5 mm (along the non-orientation surface)×8.1 mm (along the orientation surface)×43.2 mm (along the pressing surface). Next, the trunk plates are replaced with a third pair of trunk plates wherein the opening of the third pair of trunk plates is 8.6 mm. In addition, the base is replaced with a third base wherein the grooves of the third base is 8.6 mm. The plurality of 28 sliced compacts are further cut, along the pressing surface under the inert atmosphere containing Argon, using the cutter to produce a plurality of 140 sliced compacts. Each one of the 140 sliced compacts has a size of 10 mm (along a non-orientation surface)×8.1 mm (along an orientation surface)×8.3 mm (along a pressing surface). The rare earth powder produced during the cutting process are collected using a second molding and can be recycled into manufacturing another green compact.

The sliced compacts are sintered, under a sintering temperature of 1040° C. and a predetermined pressure of no more than 5×10⁻¹ Pa for a sintering duration of 7 hours, to produce a plurality of sintered compacts. After sintering, the sintered compacts are first cooled and then annealed, under the predetermined pressure of no more than 5×10⁻¹ Pa, to produce a plurality of annealed compacts. During the step of annealing, the sintered compacts are heated under a first annealing temperature of between 900° C. for a first annealing duration of 3 hours. Then, the sintered compacts are heated again under a second annealing temperature of 600° C. for a second annealing duration of 3 hours. After annealing, the annealed compacts are machined to obtain a plurality of finished Nd—Fe—B magnets. After machining, a plurality of 140 finished Nd—Fe—B magnets are obtained with each of the finished Nd—Fe—B magnets has a size of 10. mm×6.5 mm×.8.0 mm. During the cutting process, each of the sliced compact produces 50.8 g of rare earth magnet powder, which can be recycled into manufacturing another green compact. During the sintering, annealing, and machining steps, 12.0 g of waste rare earth powder is generated. According the total weight of the finished Nd—Fe—B magnet is 546.0 g and the comprehensive utilization rate of the rare earth powder is 97.7%. Twenty pieces of the finished Nd—Fe—B magnets are selected for analysis. The total rare earth element (TRE) content and the magnetic properties are listed below in Table 4.

TABLE 4
TRE and Magnetic Properties of the Finished Nd—Fe—B Magnets
of Comparative Example 2

| | TRE | Br | Hcj | | O | N |
|---|---|---|---|---|---|---|
| Sample | (wt. %) | (kGs) | (kOe) | Hk/Hcj | (ppm) | (ppm) |
| 1 | 31.09 | 13.20 | 22.2 | 0.95 | 731 | 453 |
| 2 | 31.10 | 13.16 | 22.1 | 0.96 | 742 | 466 |
| 3 | 31.05 | 13.18 | 22.0 | 0.94 | 725 | 457 |
| 4 | 31.16 | 13.20 | 22.2 | 0.95 | 718 | 447 |
| 5 | 31.10 | 13.19 | 22.1 | 0.96 | 719 | 453 |
| 6 | 31.10 | 13.19 | 22.2 | 0.96 | 713 | 467 |
| 7 | 31.07 | 13.14 | 21.9 | 0.96 | 722 | 446 |
| 8 | 31.07 | 13.17 | 21.8 | 0.96 | 676 | 28 |
| 9 | 31.09 | 13.17 | 22.0 | 0.95 | 759 | 446 |
| 10 | 31.16 | 13.17 | 22.2 | 0.97 | 753 | 445 |
| 11 | 31.10 | 13.18 | 22.0 | 0.96 | 734 | 426 |
| 12 | 31.07 | 13.19 | 21.9 | 0.96 | 731 | 434 |
| 13 | 31.17 | 13.20 | 22.3 | 0.97 | 726 | 485 |
| 14 | 31.09 | 13.20 | 21.8 | 0.96 | 725 | 494 |
| 15 | 31.08 | 13.19 | 22.0 | 0.96 | 677 | 501 |
| 16 | 31.09 | 13.19 | 22.1 | 0.96 | 724 | 466 |
| 17 | 31.16 | 13.18 | 22.2 | 0.94 | 711 | 431 |
| 18 | 31.05 | 13.21 | 21.7 | 0.94 | 724 | 436 |
| 19 | 31.16 | 13.18 | 22.3 | 0.95 | 675 | 435 |
| 20 | 31.10 | 13.20 | 22.0 | 0.96 | 687 | 446 |
| max | 31.17 | 13.21 | 22.30 | 0.97 | 759 | 501 |
| min | 31.05 | 13.14 | 21.7 | 0.94 | 675 | 426 |
| max − min | 0.12 | 0.07 | 0.6 | 0.03 | 84 | 75 |
| ave | 31.10 | 13.18 | 22.1 | 0.96 | 719 | 456 |
| δ | 0.04 | 0.02 | 0.17 | 0.01 | | |

As illustrated in Table 4 above, the maximum total rare earth element content (TRE) is 31.17 wt. %, the minimum value is 31.05 wt. %, the maximum deviation is 0.12 wt. %, the standard deviation is 0.04. The maximum value of Br is 13.21 kGs, the minimum value is 13.14 kGs, the maximum deviation of Br is 0.07 kGs, the standard deviation is 0.02. The maximum value of Hcj is 22.3 kOe, the minimum is 21.7 kOe, the average value is 22.1 kOe, the maximum deviation is 0.6 kOe, the standard deviation is 0.17. The average squareness (Hk/Hcj) value is 0.96. The average value of O element content is 719 ppm, and the average value of N element content is 456 ppm.

Comparing the results of Implementing Examples 1 and 2 with the results of Comparative Example 1, the finished Nd—Fe—B magnets prepared in accordance with Implementing Examples 1 and 3 have smaller values of maximum deviation and standard deviation for TRE, Br, and Hcj. This indicates that the Implementing Examples 1 and 2 produces finished Nd—Fe—B magnets having improved product uniformity. In addition, the value of Hcj has increased by 0.32 kOe−0.42 kOe. Further, the rare earth magnet powder obtained during the step of cutting the green compact can be directly recycled and reused in a simple manner thereby reducing the amount of rare earth magnet powder wastes generated by the conventional mechanical machining process. The comprehensive utilization ratio of the rare earth magnetic powder has increased from 89.6% to 91.7 to 95.3%.

Comparing the results of Implementing Examples 1 and 2 with the results of Comparative Example 2, the green compact in Comparative Example 2 was completely processed into corresponding size of the finished Nd—Fe—B magnet before sintering. This reduces the amount of deviation of the components and Br. But the improvement is not obvious. However, by cutting all of the surfaces of the green compact, the method in accordance with Comparative Example 2 increases the specific surface areas of the sliced compacts thereby allowing the sliced compacts to be more easily oxidized and nitrided during the cutting and the sintering process. Accordingly, the Hcj values are lowered due to the higher N and O impurities in the final product. Thus, it can be concluded that, to improve the uniformity and the magnetic properties of the finished Nd—Fe—B magnets, only one or two of the orientation surface, the non-orientation surface, or the pressing surface should be proceed.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims.

What is claimed is:

1. A method of making a finished Nd—Fe—B magnet, said method comprising the steps of:
providing a rare earth magnet powder;
forming a green compact using the rare earth magnet powder with the green compact including at least one orientation surface, at least one non-orientation surface, and at least one pressing surface;
cutting the green compact using a cutting apparatus along one of the at least one orientation surface, the at least one non-orientation surface, or the at least one pressing surface, under an inert atmosphere to produce a plurality of sliced compacts;
sintering the sliced compacts to produce a plurality of sintered compacts;
annealing the sintered compacts to produce a plurality of annealed compacts;
machining the annealed compacts to obtain a plurality of finished Nd—Fe—B magnets; and
said step of cutting is being performed before said steps of sintering, annealing, and machining.

2. The method as set forth in claim 1 wherein the at least one orientation surface is parallel to an orientation magnetic field and not in contact with a press, the at least one pressing surface is in contact with the press, and the at least one non-orientation surface is perpendicular to the at least one orientation surface and the at least pressing surface.

3. The method as set forth in claim 1 wherein said step of forming the green compact includes a step of pressing the magnetic powders under a magnetic field to produce an initial compact.

4. The method as set forth in claim 3 wherein said step of forming the green compact includes a step of isostatic pressing the initial compact under an isostatic pressure of between 150 MPa and 400 MPa to produce the green compact having a density of between 4.5-5.5 g/cm³.

5. The method as set forth in claim 1 wherein the inert atmosphere contains a noble gas or Nitrogen.

6. The method as set forth in claim 1 wherein said step of sintering is further defined as heating the sliced compacts in a vacuum furnace under a predetermined pressure of no more than 5×10⁻¹ Pa and at a sintering temperature of between 980° C. and 1040° C.

7. The method as set forth in claim 1 wherein said step of annealing is defined as heating the sintered compacts under a predetermined pressure of no more than 5×10⁻¹ Pa and at a first annealing temperature of between 800° C. and 900° C.

8. The method as set forth in claim 8 wherein said step of annealing further includes a step of heating the sintered compacts under a second annealing temperature of between 480° C. and 600° C. to produce the annealed compacts.

9. The method as set forth in claim 1 wherein said step of machining is further defined as machining the at least one orientation surface, the at least one non-orientation surface, or the at least one pressing surface that has not been processed during said step of cutting to produce the finished magnets.

10. The method as set forth in claim 1 wherein the rare earth powder has an average particle size of 4.0 μm and a composition including:
at least one light rare earth element including Pr and Nd being present at 31.10 wt. %,
a heavy rare earth element of Dy being present at 1.50 wt. %,
B being present at 0.95 wt. %,
Co being present at 1.05 wt. %,
Al being present at 0.51 wt. %,
Cu being present at 0.15 wt. %,
Ga being present at 0.12 wt. %,
Ti being present at 0.11 wt. %,
Fe being present as the balance, and inevitable impurities.

11. The cutting apparatus for cutting the green compact of claim 1, the apparatus comprising:
a frame including a first portion and a second portion;
a pair of support members extending between said first portion and said second portion connecting said first portion and said second portion and defining a chamber extending between said first portion and said second portion;
a cutter disposed in said chamber and connected to said first portion and movable along said first portion in a parallel relationship with said first portion for cutting the green compact;
a container disposed in said chamber, located between said cutter and said second portion, and defining a pocket for receiving the green compact with the container being connected to said second portion and movable between a first position and a second position with the first position being defined as said container being located adjacent to said cutter and said second position being defined as said container being located adjacent to said second portion;
an actuator disposed attached to said first portion and coupled to said cutter for moving said cutter along said first portion; and
at least one drive unit attached to said second portion and connected to said container for raising and lowering said container between said first position and said second position.

12. The cutting apparatus as set forth in claim 11 wherein said actuator includes a motor and a reducer with said motor being attached to said first portion for providing a rotational movement and said reducer being coupled to said motor for reducing the rotational speed of said motor.

13. The cutting apparatus as set forth in claim 12 further including a linking member coupled to said reducer and said cutter for translating a rotational move of said reducer into a linear movement thereby allowing said cutter to move along said first portion.

14. The cutting apparatus as set forth in claim 12 wherein said cutter includes a fixing plate movably attached to said linking member; and
a pair of side portions, opposite and spaced from one another, extending outwardly from said fixing plate.

15. The cutting apparatus as set forth in claim 16 including a plurality of wires extending between said side portions for cutting the green compact; and
a plurality of fasteners mounted on each of said side portions, disposed in an linear arrangement on said side portions, connected to said wires for adjusting wire tension.

16. The cutting apparatus as set forth in claim 15 wherein said container includes a base attached to said at least one drive units for movement with said at least one drive unit.

17. The cutting apparatus as set forth in claim 16 including a pair of guide plates, opposite and spaced from one another, extending outwardly from said base; and
a pair of trunk plates, opposite and spaced from one another, disposed adjacent to said guide plates and perpendicular to said guide plates defining said pocket for receiving the green compact.

18. The cutting apparatus as set forth in claim 17 wherein each of said trunk plates includes a plurality of openings, spaced from one another, and extending along said trunk plates; and
said base includes a plurality of grooves extending across said base and in communication with said opening for receiving said wires to allow said cutter to cutter the green compact disposed in said pocket.

19. The cutting apparatus as set forth in claim 18 wherein each of said guide plates includes a pair of guiding pins, spaced from one another, and extending through at least one of said trunk plates to ensure proper alignment of said trunk plates relative to said trunk plates.

20. The cutting apparatus as set forth in claim 19 wherein each of said guide plates includes an adjustment bolt, located between said guiding pins, extending through at least one of said trunk plates to allow for adjustments based on different sizes of the green compact.
